(19) United States
(12) Patent Application Publication
(10) Pub. No.: US 2011/0274271 A1
(43) Pub. Date: Nov. 10, 2011

(54) COUNTERMEASURE METHOD AND DEVICES FOR ASYMMETRIC ENCRYPTION

(75) Inventors: Bruno BENTEO, Vigoulet Auzil (FR); Benoît FEIX, La Ciotat (FR); Sébastien NEROT, Jouques (FR)

(73) Assignee: INSIDE CONTACTLESS, Aix-en-Provence Cedex 03 (FR)

(21) Appl. No.: 12/840,347

(22) Filed: Jul. 21, 2010

Related U.S. Application Data
(63) Continuation of application No. PCT/FR2009/000071, filed on Jan. 23, 2009.

(30) Foreign Application Priority Data
Jan. 23, 2008 (FR) 08/00344

(51) Int. Cl. H04L 9/30

(52) U.S. Cl. 380/30

(57) ABSTRACT

A countermeasure method in an electronic component implementing an asymmetric private key encryption algorithm includes generating a protection parameter, calculating, using a primitive, an intermediate data from the protection parameter, dividing the binary representation of the private key into several binary blocks, transforming each binary block using the protection parameter and, for each transformed binary block, performing an intermediate calculation using the primitive, and calculating an output data by combining the intermediate data with the intermediate calculations.

### CROSS-REFERENCE TO RELATED APPLICATIONS

This application is a Continuation of International Application No. PCT/FR2009/000071, filed Jan. 23, 2009, which was published in the French language on Sep. 17, 2009, under International Publication No. WO 2009/112686 A2 and the disclosure of which is incorporated herein by reference.

### BACKGROUND OF THE INVENTION

Embodiments of the present invention relate to a countermeasure method in an electronic component implementing an asymmetric private key encryption algorithm, resisting attacks which aim to discover the private key. Embodiments of the present invention also relate to a microcircuit device and a portable device, particularly a chip card, implementing such a method.

As shown in FIG. 1, an algorithmic application of asymmetric encryption 10 implying the use of a private key d is generally implemented by a microcircuit 12 to authenticate the transmission of a message M by a signature of this message or to protect the reception of an encrypted message M by deciphering this message, using the private key d. The private key d is, for example, stored in the microcircuit 12, which includes a memory 14 including a secure memory space 16 provided to that end and a microprocessor 18 to execute the asymmetric encryption algorithm 10.

The microcircuit devices implementing encryption algorithms are sometimes subjected to attacks which aim to determine the secret data the devices use, such as the key(s) used and possibly, in some cases, information on the actual messages. Particularly, the asymmetric encryption algorithms are subjected to attacks aiming to discover the private key, when it is used. The attacks by auxiliary channels constitute a major family of encryption techniques which utilize some properties of software or hardware implementations of the encryption algorithms.

Among the known attacks through auxiliary channels, the attacks of Simple Power Analysis (SPA) type or Differential Power Analysis (DPA) type measure the incoming and outgoing currents and voltages in the microcircuit during the execution of the asymmetric encryption algorithm so as to deduce therefrom the private key. The feasibility of this family of attacks has been demonstrated in the article of P. Kocher, J. Jaffe and B. Jun entitled “Differential Power Analysis,” published in Advances in Cryptology—Crypto 99 Proceedings, Lecture Notes In Computer Science Vol. 1666, M. Wiener, ed., Springer-Verlag, 1999.

The temporal attacks analyze the time to carry out some operations. Such attacks on asymmetric encryption algorithms are described in the article of P. Kocher, N. Koblitz entitled “Timing attacks on implementations of Diffie-Hellman, RSA, DSS, and other systems,” published in particular in Advances in Cryptology—Crypto 96, 16th annual international cryptology conference, Aug. 18-22, 1996 Proceedings.

Attacks by fault injection are also known, among which the Differential Fault Analysis (DFA) attacks, which voluntarily cause faults during the execution of the encryption algorithm, for example by disturbing the microcircuit on which it is executing. Such a disturbance may include one (or more) brief lighting(s) of the microcircuit or the generation of one or more voltage peak(s) on one of the contacts thereof. The disturbance thus makes it possible under some conditions to utilize the calculation and behavior errors generated to obtain a part of or even the whole private key.

In particular, during the execution of the asymmetric encryption algorithm known under the name of RSA (after its authors Rivest, Shamir and Adleman), a primitive using a modular exponentiation is executed. An efficient implementation of the primitive uses a binary representation of the private key d by performing iterations on each bit of this binary representation. In each iteration, the calculation made and de facto the energy consumption during the calculation depend on the value of the bit concerned. Consequently, the execution of such a primitive renders the private key particularly vulnerable to the aforementioned attacks. Likewise, during the execution of an adaptation of this asymmetric encryption algorithm using an elliptic curve, a primitive using a scalar multiplication is executed. An efficient implementation of the primitive uses a binary representation of the private key d by performing iterations on each bit of this binary representation. Likewise, in each iteration, the energy consumption during the calculation depends on the value of the bit concerned. Consequently, the execution of such a primitive also renders the value of the scalar, which may be assimilated for security reasons to a private key, particularly vulnerable to attacks.

To fight against these attacks, which are various by nature, numerous, very different solutions have been found. Embodiments of the invention more particularly relate to those which implement a countermeasure method in an electronic component implementing an asymmetric private key encryption algorithm, including generating a protection parameter, and calculating, using a primitive of the encryption algorithm, an intermediate data from an input data and the protection parameter.

These algorithms usually transform the private key using the protection parameter generated, apply the primitive to the transformed private key, and combine the result obtained with the intermediate data.

Generally, the protection parameter a is conventionally generated using a pseudorandom data generator 20, so that the execution of the primitive by the encryption algorithm 10 is also rendered random and de-correlated from the private key used, for example, by a technique typically called masking, which may also be referred to as a method for transforming or distorting data since the handling thereof is distorted as opposed to the data being used as is, made by a countermeasure section 22 of the microprocessor 18, using the protection parameter a. Thus, the intermediate data of the encryption algorithm and, as a result, the measurable currents are modified by the random protection parameter and the observation thereof does not make it possible to find the true value of the private key. On the other hand, masking does not disturb the actual algorithm, which therefore supplies the same result with or without masking.

A method of this type is for example described in the U.S. Pat. No. 6,381,699, which describes an embodiment in the field of asymmetric encryption of RSA type. In the public key e and private key d RSA algorithm, to make a signature or decryption, executing the primitive includes calculating an output data S from an input data M and the private key d the following way: S=M^{d} mod N, where N is the RSA module, product of two secret integers, and where e and d verify the relationship e·d=φ(N), the function φ(·) representing the Euler indicator function.

Let [dₙ₋₁, . . . , d₀]₂ be the binary representation of the private key d, this calculation may be performed the following way:

S=1 For i varying from n−1 to 0: S←S² mod N if dᵢ=1,S←S×M mod N

The embodiment of an RSA algorithm resisting attacks described in U.S. Pat. No. 6,381,699 includes a first step 300 during which a protection parameter d1 is generated the following way: a prime number k randomly chosen is generated such as 0<k<2¹²⁸, then z=k·φ(n), then d1 is randomly chosen such as 0<d1<z and pgcd(d1, z)=1 (pgcd is the <<greatest common denominator>> function).

The private key is then transformed the following way: d2=d×(dᵢ⁻¹mod z) mod z.

After the reception of the input data M, new transformations are carried out on d1 and d2 before performing the two following calculations (steps 345 and 350):

S₀=M^{d1} mod N (calculation from the primitive of an intermediate data S₀ from the input data M and the protection parameter d1),

S=S₀^{d2} mod N (calculation of the output data by combining the intermediate data S₀ with the application of the primitive to the transformed private key d2).

Another embodiment of an RSA algorithm resisting attacks, simpler but also described in U.S. Pat. No. 6,381,699, includes a first step during which a protection parameter d1 is randomly chosen such as 0<d1<d.

The private key is then transformed the following way: d2=d−d1.

After the reception of the input data M, new transformations are carried out on d1 and d2 before performing the two following calculations:

S1=M^{d1} mod N (calculation from the primitive of an intermediate data S₁ from the input data M and the protection parameter d1),

S₂=M^{d2} mod N, S=S₁·S₂ mod N (calculation of the output data S by combining the intermediate data S₁ with the application S₂ of the primitive to the transformed private key d2).

In each of the two above-described embodiments, the private key d is broken up into at least two exponents d1 and d2, which sizes may be compared with that of d, so that the RSA algorithm is made more complex by imposing at least two executions of the modular exponentiation instead of one. An asymmetric encryption algorithm resisting to some attacks by auxiliary channels has thus been achieved, but at the cost of a substantially increased complexity of implementation since the complexity is doubled.

It is therefore desirable to provide a method of asymmetric encryption resisting attacks of the aforementioned type and which is simple to implement.

### BRIEF SUMMARY OF THE INVENTION

An embodiment of the invention relates to a countermeasure method in an electronic component implementing an asymmetric private key encryption algorithm. The algorithm includes generating a protection parameter, calculating, using a primitive of the encryption algorithm, an intermediate data from an input data and the protection parameter, dividing the binary representation of the private key into several binary blocks, transforming each binary block using the protection parameter and, for each binary block transformed, performing an intermediate calculation using the primitive, and calculating an output data by combining the intermediate data with the intermediate calculations.

Thus the protection parameter is used to transform the binary blocks rather than the complete binary representation of the private key. Consequently, the size of the binary representation of the protection parameter is lower than that of the binary representation of the private key, i.e., on the order of that of the binary blocks. The calculation is simplified accordingly because, even if the number of executions of the primitive is increased, the executions operate on binary data of smaller sizes. The execution of the asymmetric encryption algorithm may thus be protected by substantially reducing the complexity thereof in relation to the conventional countermeasure methods.

According to one embodiment, the countermeasure method includes dividing the binary representation of the private key so that the size of each binary block is greater or equal to that of the binary representation of the protection parameter.

According to one embodiment, the countermeasure method includes dividing the binary representation of the private key into several binary blocks so that the sum of the sizes of the binary blocks is greater than the size of the binary representation of the private key.

According to one embodiment, the countermeasure method includes randomly determining in an iterative way the size of each binary block so that the value of each binary block is greater than the value of the protection parameter.

According to one embodiment, the countermeasure method further includes choosing the size k of the binary representation of the protection parameter such that there exists an integer u≧2, such that n=k·u, where n is the size of the binary representation of the private key, and dividing the binary representation of the private key into u binary blocks of k bits each.

According to one embodiment, the primitive is a modular exponentiation of the input data by the private key for performing an encryption algorithm of RSA or RSA CRT type.

According to one embodiment, the countermeasure method includes previously masking the RSA module and the input data.

According to one embodiment, the primitive is a scalar multiplication of the input data by the private key, for performing an encryption algorithm based on an elliptic curve wherein the input data is a predetermined point of the elliptic curve.

According to one embodiment, the countermeasure method includes previously masking the predetermined point of the elliptic curve.

According to one embodiment, the countermeasure method further includes initially generating, in a reproducible way, at least one verification parameter before any execution of the primitive, regenerating the verification parameter during or after the execution of the primitive, and comparing the regenerated verification parameter to the initially generated verification parameter.

According to one embodiment, the step of regenerating and comparing is performed at each iteration of the primitive when the primitive is applied to a transformed binary block.

According to one embodiment, the countermeasure method includes triggering an alert and scrambling at least the private key, if the step of regenerating and comparing indicates a difference between the initially generated verification parameter and the regenerated verification parameter.

According to one embodiment, the generation of the protection parameter and/or the verification parameter includes defining a generating function, by successive applications to at least one predetermined secret parameter stored in memory, of a sequence of values only determinable from the secret parameter and the function, and generating the protection parameter and/or the verification parameter in a reproducible way from at least one value of the sequence.

According to one embodiment, the countermeasure method includes defining a plurality of functions, each function generating, by successive applications to at least one corresponding predetermined secret parameter stored in memory, of a corresponding sequence of values only determinable from the corresponding secret parameter and the corresponding function, combining the plurality of sequences of values generated using a predefined relationship to generate a new sequence of values, and generating the protection parameter and/or the verification parameter in a reproducible way from at least one value of this sequence.

According to one embodiment, the countermeasure method includes defining a generating function, by successive applications to at least one predetermined secret parameter stored in memory, of a sequence of values only determinable from the secret parameter and the function, combining the sequence of values generated with public parameters of the encryption algorithm to generate a new sequence of values, and generating the protection parameter and/or the verification parameter in a reproducible way from at least one value of the sequence.

Another embodiment of the invention includes providing a microcircuit device, including a microprocessor to implement a countermeasure method of an asymmetric private key encryption algorithm, at least one secure memory to store the private key, and a data generator for the generation of a protection parameter, configured to calculate, using a primitive of the encryption algorithm, an intermediate data from an input data and the protection parameter, divide the binary representation of the private key into several binary blocks, transform each binary block using the protection parameter and, for each binary block transformed, perform an intermediate calculation using the primitive, and calculate an output data by combining the intermediate data with the intermediate calculations.

According to one embodiment, the microprocessor is configured to randomly determine, in an iterative way, the size of each binary block so that the value of each binary block is greater than the value of the protection parameter.

According to one embodiment, the data generator is configured to choose the size k of the binary representation of the protection parameter such that there exists an integer u≧2 such that n=k·u, where n is the size of the binary representation of the private key, and the microprocessor is configured to divide the binary representation of the private key into u binary blocks of k bits each.

According to one embodiment, the primitive is a modular exponentiation of the input data by the private key for performing an encryption algorithm of RSA or RSA CRT type.

According to one embodiment, the primitive is a scalar multiplication of the input data by the private key, for performing an encryption algorithm based on an elliptic curve wherein the input data is a predetermined point of the elliptic curve.

According to one embodiment, the microcircuit device is further configured to initially generate, in a reproducible way, at least one verification parameter before any execution of the primitive, regenerate this verification parameter during or after the execution of the primitive, and compare the regenerated verification parameter with the verification parameter initially generated.

According to one embodiment, the data generator is configured to generate the protection parameter and/or the verification parameter by defining a generating function, by successive applications to at least one predetermined secret parameter stored in memory, of a sequence of values only determinable from the secret parameter and the function, and generating the protection parameter and/or the verification parameter in a reproducible way from at least one value of the sequence.

According to one embodiment, the data generator is configured to define a plurality of functions, each function generating, by successive applications to at least one corresponding predetermined secret parameter stored in memory, of a corresponding sequence of values only determinable from the corresponding secret parameter and the corresponding function, combine the plurality of sequences of values generated using a predefined relationship to generate a new sequence of values, and generate the protection parameter and/or the verification parameter in a reproducible way from at least one value of the sequence.

According to one embodiment, the data generator is configured to define a generating function, by successive applications to at least one predetermined secret parameter stored in memory, of a sequence of values only determinable from the secret parameter and the function, combine the sequence of values generated with public parameters of the encryption algorithm to generate a new sequence of values, and generate the protection parameter and/or the verification parameter in a reproducible way from at least one value of the sequence.

Another embodiment of the invention includes supplying a portable device, a chipcard in particular, including a microcircuit device such as previously described.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 schematically shows the structure of a microcircuit device of conventional type;

FIG. 2 schematically shows the structure of a microcircuit device according to a first embodiment of the invention;

FIG. 3 schematically shows a chipcard including the device of FIG. 2;

FIG. 4 shows the successive steps of a first countermeasure method implemented by the device of FIG. 2;

FIG. 5 shows the successive steps of a second countermeasure method implemented by the device of FIG. 2;

FIG. 6 shows the successive steps of a third countermeasure method implemented by the device of FIG. 2;

FIG. 7 shows the successive steps of a fourth countermeasure method implemented by the device of FIG. 2;

FIG. 8 shows the successive steps of a fifth countermeasure method implemented by the device of FIG. 2;

FIG. 9 schematically shows the structure of a microcircuit device, according to a second embodiment of the invention; and

FIG. 10 shows the successive steps of a countermeasure method implemented by the device of FIG. 9.

### DETAILED DESCRIPTION OF THE INVENTION

### First Embodiment of the Invention

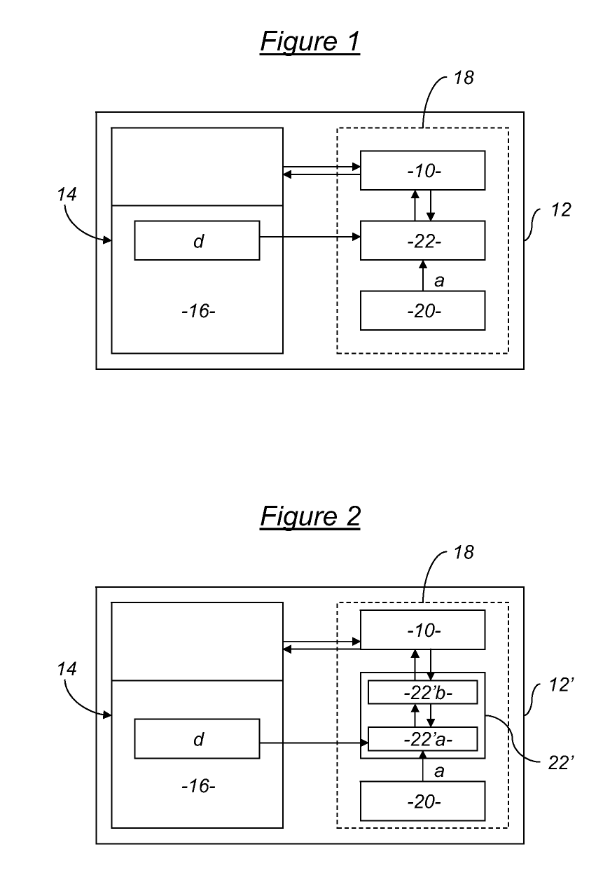

The microcircuit device 12′ shown in FIG. 2 includes, like that shown in FIG. 1, an algorithmic application of asymmetric encryption 10, a memory 14 including a secure memory space 16 to store, in particular, a private key d intended for use by the application 10, a microprocessor 18 and a pseudorandom data generator 20 to supply a protection parameter a. The device 12′ also includes a countermeasure section 22′, which brings an improvement to the existing countermeasures, in particular to the countermeasure section 22 previously described.

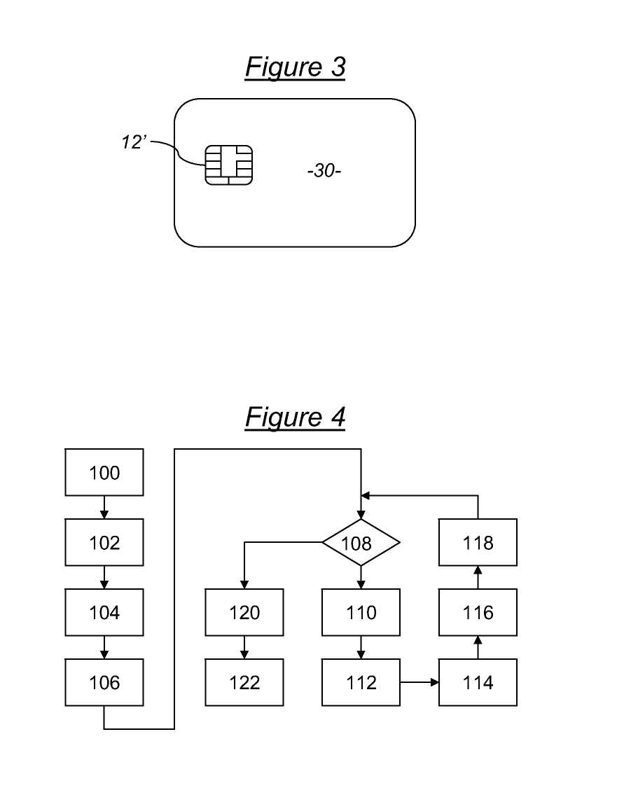

In addition, the device 12′ is, for example, integrated into a portable device, in particular in the form of a secure chipcard 30, as shown in FIG. 3.

It is to be noted that, although the algorithmic encryption application 10 and the countermeasure section 22′ are shown as distinct, they may actually be imbricate into the same hardware or software implementation of an asymmetric encryption algorithm including a countermeasure.

Contrary to the device 12, in the device 12′ the countermeasure section 22′ includes (i) a section 22′a to divide the binary representation of the private key d into several binary blocks Dᵤ₋₁, . . . , D₀, which sum of sizes is, for example, equal to the size of the binary representation of the private key; the binary representation of the private key d may therefore be written d_{bin}=[Dᵤ₋₁, . . . , D₀]₂, and (ii) a section 22′b to transform each binary block Dᵢ using the protection parameter a and, for each transformed binary block D′ᵢ, to perform an intermediate calculation using the primitive.

More precisely, the generator 20 may be designed to generate a protection parameter a, which size of binary representation is, at most, equal to half the size of the binary representation of the private key d. Likewise, the section 22′a may be designed to divide the binary representation of the private key so that the size of each binary block is greater or equal to that of the binary representation of the protection parameter. The algorithmic application of asymmetric encryption 10 then executes the primitive using data which size does not exceed half that of d_{bin}. The benefit in time of calculation is very substantial.

Different countermeasure methods complying with embodiments of the invention may be implemented by the device of FIG. 2.

A first method of this type, achieving an encryption of RSA type of module N on a message M, is shown in FIG. 4. Conventionally, the algorithm RSA requires using a private key d which size n of binary representation is, for example, equal to n=1024 bits. If dᵢ is the bits of this binary representation, d_{bin}=[dₙ₋₁, . . . , d₀]₂.

Let S=Exp (M, D, N, S) be the following primitive:

For i varying from j−1 to 0: S←S² mod N if Dᵢ=1, S←S·M mod N Output the value S

where M and S are respectively the input and output data of the primitive, N is the RSA module and D is a binary exponent of size j such as D=[Dⱼ₋₁, . . . , D₀]₂, where Dᵢ are the binary values of D.

During a first step 100, the pseudorandom data generator 20 generates a protection parameter a, which size k of binary representation is well inferior to n, for example k=32 bits.

During a second optional step 102, a verification parameter r1 is generated. The verification parameter r1 is, for example, determined by the application of a predetermined function COMB, particularly combining a value v generated by the generator 20 and kept in memory, the protection parameter a, and other parameters of the algorithm RSA.

During the same optional step 102, the message M and the RSA module N may also be transformed using functions g and h:

N←h(N), then M←g(M) mod N,

where g and h are for example functions defined by g(x)=x+r2·N and h(x)=r3·x, or g(x)=r2·x and h(x)=x, where r2 and r3 may be random variables generated by the generator 20 and kept in memory.

Then, during an exponentiation step 104, a data V is set to 1, and the following calculation is performed:

V=Exp (M, a, N, V),

where V represents an intermediate data calculated using the primitive Exp from the input data M and the protection parameter a.

During a reset step 106, the output data S is set to 1 and a counter i is set to n−1.

Then, during a test step 108, the value of the counter i is tested. If this value is strictly positive, a step 110 is performed, if not, an optional step 120 followed by a final step 122 or directly the final step 122.

During step 110, an integer j is determined, for example randomly, which verifies the following conditions:

(a) k≦j<i, and

(b) dᵢ·2^{j-1}. . . +dᵢ₋ⱼ·2⁰>a.

In addition, if j is such as i−j<k, the value of the counter i is allocated to j.

Then, during a step 112, the value D=dᵢ·2^{j}+dᵢ₋₁·2^{j-1}+. . . +dᵢ₋ⱼ·2⁰−a is calculated. The value D represents a binary block of the private key d transformed by a. Then, during a step 114, the following intermediate calculation is performed, using the binary block D:

S=Exp (M, D, N, S).

Then, during a step 116, the intermediate value V is combined with the value S obtained at step 114, the following way:

S←S·V mod N.

Then the value i−j is allocated to the counter i during a step 118. Then the test step 108 is returned to.

Step 120, which is optional, follows step 108 when the value of the counter i is equal to zero and provided that the optional step 102 has been performed. During step 120, the parameter r1 is calculated again, using the function COMB and the values, public and/or kept in memory, used by the function. If the value of r1 changes between step 102 and 120, it may be concluded that an attack by fault injection occurred between the two steps. An alert is transmitted by the encryption application 10. During step 120, the output data S is also unmasked, according to the functions g and h which have been used to mask the input data M. According to the alert transmitted by the encryption application 10, the inverse transformation (unmasking) performed with a fault allows an attack by fault injection to be blocked.

Eventually, during a last step 122, the encryption application 10 outputs the value S.

It is to be noted that the first method described above implies n+k exponentiation iterations: k iterations during step 104 and n iteration in the loop of steps 108 to 118. When k is much smaller than n (for example when k=32 whereas n=1024), the extra cost of the countermeasure on the algorithm RSA is very low. It is in any case much lower than that of prior art solutions applying at least 2n exponentiation iterations.

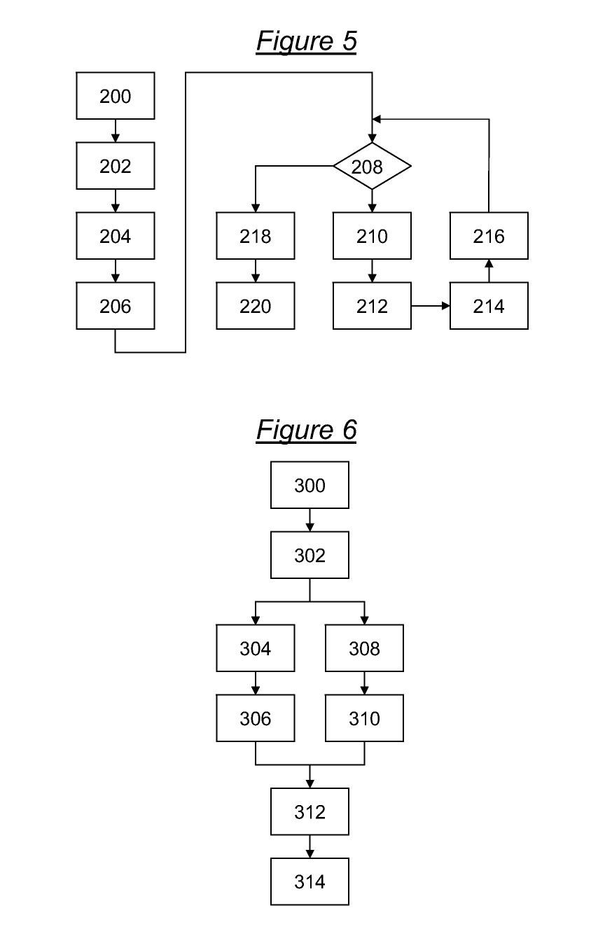

A second countermeasure method complying with embodiments of the invention which may be implemented by the device of FIG. 2, and also achieving an encryption of RSA type of module N on a message M, is shown by FIG. 5. It is a variation of the first method wherein, the size k of the protection parameter a is chosen such that there exists an integer u, such that n=k·u, the value j (step 110) is fixed at k and the condition (b) is not imposed. The countermeasure method is therefore simplified.

Steps 200, 202 (optional) and 204 of the second method remain identical to steps 100, 102 (optional) and 104 previously described.

Then, during a reset step 206, the output data S is set to 1 and a counter i is set to u−1. During the same step, the binary representation of the private key d is divided into u successive blocks Dᵢ, each of size k, such that d_{bin}=[Dᵤ₋₁, . . . , D₀]₂. As a result, for any i, 0≦i<u: D₁=[dₖ₍ᵢ₊₁₎₋₁, . . . , Dₖᵢ]₂. In addition, a vector C of binary carry digits C=[Cᵤ₋₁, . . . , C₀]₂ is calculated and kept in memory. It is calculated by induction the following way:

C₀=0, Cᵢ=(Dᵢ−a−Cᵢ₋₁)/2^{k}.

Then, during a test step 208, the value of the counter i is tested. If the value is strictly positive, a step 210 is performed, if not, an optional step 218 followed by a final step 220 or directly the final step 220 is performed.

During step 210, the value D′ᵢ=Dᵢ−a−Cᵢ is calculated. For good operation of the algorithm, if i=u−1 and if Cᵤ₋₁=1, it means that D′ᵢ is lower than a and in that case, D′ᵢ=Dᵢ is kept. The value D′ᵢ represents the i^{th} binary block of the private key d transformed by a. It is to be noted that one of the interests of the second method is to require only the storing of the vector and not that of the transformed blocks D′ᵢ.

Then, during a step 212, the following intermediate calculation is performed, using the binary block D′ᵢ:

S=Exp (M, D′ᵢ, N, S).

Then, during a step 214, the intermediate value V is combined with the value S obtained at step 212, the following way:

S←S·V mod N.

Then the value i−j is allocated to the counter i during a step 216. Then the test step 208 is returned to.

Steps 218 and 220 are identical to steps 120 and 122 previously described.

It is also to be noted that the second method described above implies n+k exponentiation iterations.

A third countermeasure method complying with embodiments of the invention which may be implemented by the device of FIG. 2, and achieving an encryption of RSA CRT type (i.e. RSA algorithm using the Chinese remainder theorem) of module N=p·q on a message M, is shown by FIG. 6. Conventionally, the algorithm RSA CRT constitutes an alternative to the algorithm RSA to perform a signature or decryption: it is four times quicker. It defines the following parameters:

dp=d mod (p−1),

dq=d mod (q−1),

A=p⁻¹ mod q.

It then replaces the exponentiation calculation S=M^{d} mod N by two exponentiation calculations that are much simpler to execute due to the size of p and q in relation to that of N: Sₚ=M^{dp} mod p and S_{q}=M^{dq} mod q. Eventually, S is found using the following calculation:

S=[((S_{q}−Sₚ)·A mod q)·p+Sₚ] mod N.

Steps 300 and 302 (optional) of the third method remain identical to steps 100, 200 and 102, 202 (optional) previously described.

Then, during an exponentiation step 304, a data Vp is set to 1, and the following calculation is performed:

Vp=Exp (M, a, p, Vp),

where Vp represents an intermediate data calculated using the primitive Exp from the input data M and the protection parameter a.

After step 304, during a step 306 including a series of steps in loop and corresponding to the already described steps 106 to 118 or 206 to 216 except for the replacement of the exponent d by dp and the module N by p, the calculation Sₚ=M^{dp} mod p is performed.

During an exponentiation step 308, a data Vq is set to 1, and the following calculation is performed:

Vq=Exp (M, a, q, Vq),

where Vq represents an intermediate data calculated using the primitive Exp from the input data M and the protection parameter a.

After step 308, during a step 310 including a series of steps in loop and corresponding to the already described steps 106 to 118 or 206 to 216 except for the replacement of the exponent d by dp and the module N by q, the calculation Sₚ=M^{dp} mod p is performed.

The order in which steps 304 to 310 are executed is not set. Indeed, it is only required that steps 304-310 be executed after step 302, that step 304 is executed before step 306, and that step 308 is executed before step 310. At the output of loops, i.e. at the end of steps 306 and 310, an optional step 312 is performed, followed by a final step 314 or directly the final step 314.

The optional step 312 is identical to step 120 and is only performed if the optional step 302 has been executed.

During the final step 314, the encryption algorithm 10 calculates the value of S from Sₚ and S_{q} as previously indicated and outputs this value.

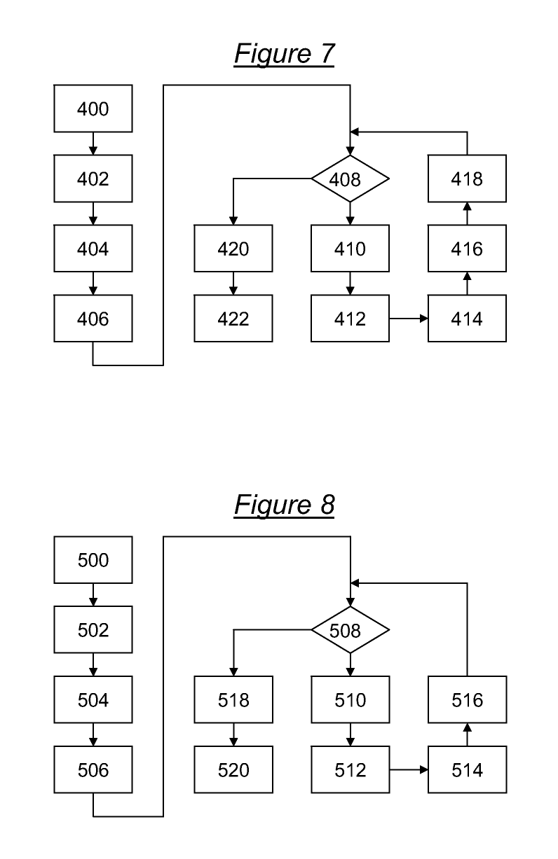

A fourth countermeasure method complying with embodiments of the invention which may be implemented by the device of FIG. 2, and achieving an encryption of elliptic curve type on a message M, is shown by FIG. 7. Conventionally, an asymmetric elliptic curve encryption algorithm, also called Elliptic Curve Cryptosystem (ECC), requires using a private key d which size n is much smaller than that necessary for the algorithm RSA for an equivalent security level. Generally, the binary representation of the private key d must be at least equal to n=160 bits.

In an algorithm ECC with private key d, to perform a signature or decryption, “executing the primitive” includes calculating an output data Q from an input data P and the private key d the following way:

Q=d·P, where P and Q are points of a predetermined elliptic curve on a finite field GF(p) where p is a prime number strictly superior to 3 (for example the elliptic curve y²=x³+10x+5 in the field GF(13)), and where the operation “·” is a scalar multiplication, here of the point P by the scalar d.

Let [dₙ₋₁, . . . , d₀]₂ be the binary representation of the private key d, the calculation may be performed as follows:

Q=0 For i varying from n−1 to 0: Q←2Q if dᵢ=1,Q←Q+P

where “2Q” and “Q+P” are respectively operations of point doubling and point addition which formulas are conventionally determined, and not detailed here, by the elliptic curve chosen and the order of the field GF(p).

In the following description, S ScalarMult (P, D, Q) refers to the following primitive:

For i varying from j−1 to 0: Q←2Q if dᵢ=1, Q←Q+P Output the value Q

where P and Q are respectively the input and output data of the primitive, and D is a binary exponent of size j such as D=[Dⱼ₋₁, . . . , D₀]₂, where Di are the binary values of D.

During a first step 400, the pseudorandom data generator 20 generates a protection parameter a, which size k of binary representation is much smaller than n, for example k=32 bits.

During a second optional step 402, a verification parameter r is generated. The verification parameter r is, for example, determined by the application of a predetermined function COMB, particularly combining a value v generated by the generator 20 and kept in memory, the protection parameter a and other parameters of the algorithm ECC.

During this same optional step 402, the coordinates Px and Py of the point P may also be transformed using a function g which applies to the coordinates: P←g(Px, Py) mod N.

Then, during a step 404, a data V is set to 0, and the following calculation is performed:

V=ScalarMult (P, a, V),

where V represents an intermediate data calculated using the primitive ScalarMult from the input data P and the protection parameter a.

During a reset step 406, the output data Q is set to 0 and a counter i is set to n−1.

Then, during a test step 408, the value of the counter i is tested. If the value is strictly positive, a step 410 is performed, if not, an optional step 420 followed by a final step 422 or directly the final step 422.

During step 410, an integer j is determined, for example randomly, which verifies the following conditions:

(a) k≦j<i, and

(b) dᵢ·2^{j}+dᵢ₋₁·2^{j-1} . . . +dᵢ₋ⱼ·2⁰>a.

In addition, if j is such as i−j<k, the value of the counter i is allocated to j.

Then, during step 412, the value D=dᵢ·2^{j}+dᵢ₋₁·2^{j-1}+. . . +dᵢ₋ⱼ·2⁰−a is calculated. The value D represents a binary block of the private key d transformed by a. Then, during a step 414, the following intermediate calculation is performed, using the binary block D:

Q=ScalarMult (P, D, Q).

Then, during a step 416, the intermediate value V is combined with the value Q obtained at step 414, the following way:

Q←Q+V.

Then the value i−j is allocated to the counter i during a step 418. Then the test step 408 is returned to.

Step 420, which is optional, follows step 408 when the value of the counter i is equal to zero and provided that the optional step 402 has been performed. During step 420, the parameter r is calculated again, using the function COMB and the values, public and/or kept in memory, used by the function. If the value of r changes between step 402 and 420, it may be concluded that an attack by fault injection occurred between the two steps. An alert is then transmitted by the encryption application 10. During step 420, the output data Q is also unmasked, according to the function g which has been used to mask the input data P. According to the alert transmitted by the encryption application 10, the inverse transformation (unmasking) performed with a fault allows an attack by fault injection to be blocked.

Eventually, during a last step 422, the encryption application 10 outputs the value Q.

It is also to be noted that the fourth method described above implies n+k scalar multiplication iterations: k iterations during step 404 and n iterations in the loop of steps 408 to 418. When k is much smaller than n (for example when k=32 whereas n=160 or more), the extra cost of the countermeasure on the algorithm ECC is very low. It is in any case much lower than that of prior art solutions implying at least 2n scalar multiplication iterations.

Alternately, during step 404, the data V is reset to 0, and the following calculation is performed: V=ScalarMult (−P, a, V). In this case, during step 412, the value of D=dᵢ·2^{j +d}ᵢ₋₁·2^{j-1}+. . . +dᵢ₋ⱼ·2⁰+a is calculated. This constitutes another possible transformation of the private key d by a.

A fifth countermeasure method complying with embodiments of the invention which may be implemented by the device of FIG. 2, and also achieving an elliptic curve encryption, is shown by FIG. 8. It is a variation of the fourth method wherein, the size k of the protection parameter a is chosen such that there exists an integer u such that n=k·u, the value of j (step 410) is fixed to k and the condition (b) is not imposed. The countermeasure method is therefore simplified.

Steps 500, 502 (optional) and 504 of the fifth method remain identical to steps 400, 402 (optional) and 404 previously described.

Then, during a reset step 506, the output data Q is set to 0 and a counter i is set to u−1. During the same step, the binary representation of the private key d is divided into u successive blocks Dᵢ, each of size k, such as d_{bin}=[Dᵤ₋₁, . . . , D₀]₂. It comes that, for any i, 0≦i<u: Dᵢ=[dₖ₍ᵢ₊₁₎₋₁. . . , Dₖᵢ]₂. In addition, a vector C of binary carry digits C=[Cᵤ₋₁, . . . , C₀]₂ is calculated and kept in memory. It is calculated by induction the following way:

C₀=0, Cᵢ=(Dᵢ−a−Cᵢ₋₁)/2^{k}.

Then, during a test step 508, the value of the counter i is tested. If the value is strictly positive, a step 510 is performed, if not, an optional step 518 followed by a final step 520 or directly the final step 520.

During step 510, the value D′ᵢ=Dᵢ−a−Cᵢ is calculated. For good operation of the algorithm, if i=u−1 and if Cᵤ₋₁=1, it means that D′ᵢ is lower than a and in that case, D′ᵢ=Dᵢ is kept. The value D′ᵢ represents the i^{th} binary block of the private key d transformed by a. It is to be noted that one of the interests of the second method is to only require storing the vector of binary carry digits C, and not the transformed blocks D′ᵢ.

Then, during a step 512, the following intermediate calculation is performed, using the binary block D′ᵢ:

Q=ScalarMult(P, D′ᵢ, Q).

Then, during a step 514, the intermediate value V is combined with the value Q obtained at step 512, the following way:

Q←Q+V.

Then the value i−1 is allocated to the counter i during a step 516. Then the test step 508 is returned to.

Steps 518 and 520 are identical to steps 420 and 422 previously described.

It is also to be noted that the second method described above applies n+k scalar multiplication iterations.

As for the fourth method, alternately, during step 504, the data V is set to 0, and the following calculation is performed: V=ScalarMult (−P, a, V). In this case, during step 506, the calculation of the vector of binary carry digits is modified the following way:

C₀=0, Cᵢ=(Dᵢ+a+Cᵢ₋₁)/2^{k}.

In this case, during step 510, the value D′ᵢ=Dᵢ+a+Cᵢ is calculated. This constitutes another possible transformation of the private key d by a.

### Second Embodiment of the Invention

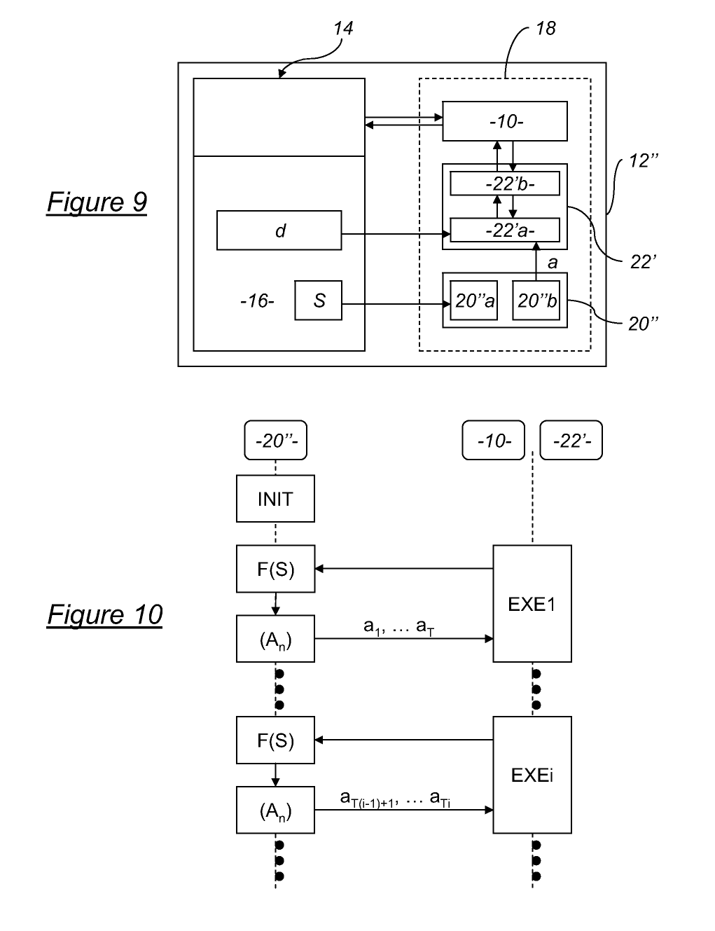

The microcircuit device 12″ shown in FIG. 9 includes, like that shown in FIG. 2, an algorithmic encryption application 10, a memory 14 including a secure memory space 16, a microprocessor 18 and a countermeasure section 22′. The device 12″ is, for example, integrated into a portable device, in particular in the form of a secure chipcard 30, as shown in FIG. 3. It is however to be noted that, although the algorithmic encryption application 10 and the countermeasure section 22′ are shown as distinct, they may actually be imbricate into a same implementation of an encryption algorithm including a countermeasure.

The countermeasure section 22′ of the device 12″ includes, like that of the device 12′ (i) a section 22′a to divide the binary representation of the private key d into several binary blocks Dᵤ₋₁, . . . , D₀, which sum of sizes is, for example, equal to the size of the binary representation of the private key, and (ii) a section 22′b to transform each binary block Dᵢ using a protection parameter a and, for each transformed binary block D′ᵢ, to perform an intermediate calculation using the primitive.

Contrary to the device 12′, in the device 12″ the pseudorandom data generator 20 of conventional type is replaced by a data generator 20″ including (i) a section 20″a for applying a predefined function F to at least one predetermined secret parameter S for the generation of a sequence of values only determinable from the secret parameter and the function F, and (ii) a section 20″b for supplying at least one protection parameter a in a reproducible way from a value of this sequence.

The section 20″a is in fact a software or hardware implementation of the function F.

The secret parameter S is stored in the secure memory 16 and supplied in input of the section 20″a of the generator 20″, whereas the protection parameter a is supplied, in output of the section 20″b, to the countermeasure section 22′.

In this second embodiment, the parameter a is therefore not a random variable in the conventional meaning mentioned in state-of-art documents. It is a deterministic result resulting from the calculation of the function F executed by the generator 20″ on at least one secret parameter S, which may be proper to the chipcard 30 on which the microcircuit 12′ is arranged. The secret parameter derives, for example, from public data of the device 30.

The repeated application of the function F to S generates a sequence (Aₙ), which elements are the source of the protection parameter(s) supplied by the generator. Globally, the generator may supply as many parameters a coming from values of the sequence (Aₙ) as necessary according to the countermeasure application implemented in the card 30. This sequence (Aₙ) may only be reproduced knowing the generating function F and the initial deterministic elements the function uses (the parameter S).

Each protection parameter a may directly come from an element Aₙ of the sequence (Aₙ): in other words, a=Aₙ. Alternately, the element Aₙ may be subjected to processing before supplying the parameter a. For example, a may be the result of a calculation a=Aₙ XOR kₙ, where kₙ is a secret transformation constant.

Admittedly, if the sequence (Aₙ) is cyclic and/or operates in a finite set of elements, the space of the values Aₙ generated must be great enough to resist attacks. Indeed, the greater the space considered, the more reliable the countermeasure.

First, several non-limiting examples of sequences of values (Aₙ) which may be supplied by a generator 20″ according to the second embodiment of the invention will be presented. Then, several possible uses of such sequences of values will be shown, to supply protection parameters in particular to the five countermeasure applications of asymmetric encryption previously described with reference to FIGS. 4 to 8.

### Examples of Functions Generating Sequences of Values to Supply Protection Parameters

### 1) Functions Based on Arithmetic-Geometric Progressions

If the sequence of values (Aₙ) is defined using the integer-valued function F by the following relationship:

Aₙ₊₁=F(Aₙ)=q·Aₙ+r,

where q and r are secret parameters constituting, with the initial element A₀ of the sequence, the secret parameters S previously mentioned, it is possible to supply protection parameters coming from an arithmetic-geometric progression. The protection parameters are, for example, the elements of the sequence (Aₙ).

If r=0, it is a geometric sequence a term Aᵢ of which, used at a precise step of the encryption, may be found using the secret parameters q and A₀ the following way:

Aᵢ=qⁱ·A₀.

If q=1, it is an arithmetic sequence in which a term Aᵢ may be found using the secret parameters r and A₀ the following way:

Aᵢ=r·i+A₀.

If r is not equal to zero and q is different from 1, it is an arithmetic-geometric sequence in which a term Aᵢ may be found using the secret parameters q, r and A₀ the following way:

Aᵢ=qⁱ·A₀+r·(q¹−1)/(q−1).

The space of the elements of the sequence (Aₙ) may also be reduced by an integer m using the following relationship:

Aₙ₊₁=F(Aₙ) modulo m=(q·Aₙ+r) modulo m.

It may be noted that if m is a prime number, this sequence takes the form of the group of reverse affine transformations on the finite field GF(m)={0, 1, . . . , m−1}.

m may also be chosen as a power of 2, to generate sequences of elements with a constant number of bits. For example, if it is wished to generate sequences of parameters Aᵢ with k bits, m=2^{k} is chosen.

Preferably, m is part of the secret parameters to be kept in the secure memory of the device.

### 2) Functions Defining a Cyclic Multiplicative Group

Let GC be a cyclic group with m elements and a value a as generator element and the multiplication as internal principle of composition: GC={a, a², a^{m}}. The sequence of values (Aₙ) may be defined the following way:
the initial element A₀ is chosen as being the generator element a to which the internal principle of composition of the group GC is applied k times,
the internal principle of composition of the group GC is applied k′ times to pass from the element Aᵢ to the element A,ᵢ₊₁.

The secret parameters S used by the function generating the sequence (Aₙ) are then, for example, the generator element a and the values k, k′ and m. In addition, like before, the protection parameters generated are for example the elements of the sequence (Aₙ).

### 3) Functions Defining a Frobenius Group

Let GF(q) be a finite field, where the order q is a prime number of k bits. The group of reverse affine transformations on this finite field is a Frobenius group. An interesting property of Frobenius groups is that no non-trivial element fixes more than one point.

In this context, the usable affine transformations take the form of functions y=f(x)=b·x+c, where b≠0 and the operations are made in the field GF(q). It is therefore possible to define a function generating the sequence (Aₙ) applying to predetermined secret parameters q, b, c and A₀. By choosing for example q=2¹⁶+1 and, in hexadecimal notation, b=0c4cd3, c=0x76bb, A₀=0xef34, a sequence beginning by the terms A₁=0xc6cf, A₂=0x8baf, A₃=0x620d, A₄=0x0605, A₅=0xe70c, A₆=0x3049, A₇=0xe069, A₈=0x55ee, and so on is obtained.

### 4) Functions Coming from a Shift Register with Linear Feedback (Register of LFSR Type)

These types of functions choose a secret parameter A₀, for example of 16 bits, and a LFSR shift register, for example with a corresponding output of 16 bits. If the size of the LFSR register is m, then a term Aₜ₊ₘ of the sequence (Aₙ) is determined by the m previous terms using a linear equation of the type:

Aₜ₊ₘ=αₘ·Aₜ+αₘ₋₁·Aₜ₊₁+. . . +α₁Aₜ₊ₘ₋₁, where the αᵢ take the value 0 or 1.

### 5) Functions Defining a Calculation of Cyclic Redundancy Check (CRC)

These types of functions choose a secret parameter A₀, for example of 16 bits, and a corresponding polynomial CRC among those conventionally used in CRC calculations, for example the polynomial CRC-16 (X¹⁶+X¹⁵+X²+1) or the polynomial CRC CCITT V41 (X¹⁶+X¹²+X⁵+1). A term Aₙ₊₁ of the sequence (Aₙ) is determined according to the previous term Aₙ by the relationship Aₙ₊₁=F(Aₙ), where F makes a CRC calculation based on the chosen polynomial.

### 6) Combinations of Sequences of Values

It is indeed also possible to calculate several sequences of values, each for example according to one of the methods detailed hereinbefore, and to combine them using a predefined function to generate a new sequence of values to be used as protection parameter. The sequence (Aₙ) is thus generated according to two other sequences (A′ₙ) and (A″ₙ), by calculating for each index n, Aₙ=T(A′ₙ, A″ₙ).

The function T concerned may be a secret matrix of values, the values A′ₙ and A″ ₙ then respectively referring to a row and a column of the matrix.

### 7) Combinations Supplying a Sequence of Values and Public Data

The sequence (Aₙ) may be generated from a first sequence (A′ₙ), also according to public data, for example, such as data used during the execution of the encryption application, with countermeasure and not secret. Among these data, according to the applications, the message M (clear or coded), a public key e, or the like may be cited. The values of the sequence used as protection parameters are then calculated using any function COMB combining all these data:

Aₙ=COMB(A′ₙ, M, e, . . . ).

An advantage of this combination is that the sequence of values (Aₙ) may be used, not only to feed protection parameters to the countermeasure application of the encryption algorithm, but also to detect attacks by fault injection (in particular on public data). Indeed, by regeneration of the sequence (A′ₙ) using the secret parameter(s), at the end of the execution of the encryption algorithm for example, but before performing the inverse operation of the initial transformation using a regenerated protection parameter, then by using this regenerated sequence (A′ₙ) and public data as they appear at the end of execution, it is possible to check if the application of the function COMB produces the same sequence of values (Aₙ) or not and therefore if public data have been affected or not during the execution.

### Examples of Use of a Sequence of Values Generated According to one of the Aforementioned Methods in a Countermeasure Method of Asymmetric Encryption, According to the Second Embodiment of the Invention

### 1) General Principle of the Second Embodiment

Generally, each time an algorithmic countermeasure is used, the generation of random variables introduced by the countermeasure is recommended, as it has been described in the first embodiment using a pseudorandom data generator 20. As mentioned with reference to FIG. 9, the generation of random variables may be replaced by the non-random generation of parameters coming from one or more sequence(s) of values obtained using at least one secret parameter.

FIG. 10 shows an example of steps performed by a method according to the second embodiment of FIG. 9, applied to the execution of an asymmetric encryption algorithm with countermeasure, using T protection parameters a₁, . . . a_{T}. By execution, all of the protection parameters may be extracted from a same sequence of values (Aₙ) generated by the section 20′a.

During a first step INIT performed by the generator 20″, a counter i is set to 0. The counter i is intended for keeping in memory the number of times that the asymmetric encryption algorithm has been executed since the reset step INIT, as long as another reset is not performed.

During this step, the secret parameter S (or the parameters S when there are more than one), from which the sequence of values must be generated, is defined. It may be kept from a previous reset, but may also be generated based on a new value on the occasion of the reset. It is, for example, generated from unique identification data, such as public data of the device 30. It may also be generated from parameters or physical phenomena linked to the microcircuit at a given time, which may be random. In any case, it is kept in memory in a secured way, to allow the microcircuit to regenerate at anytime a same sequence of values (Aₙ) using the function implemented by the section 20″a.

The reset step INIT may be unique in the microcircuit life cycle, performed during the design by the manufacturer, or reproduced several times, for example regularly or each time the counter i reaches a value imax.

During a first execution EXE1 of the asymmetric encryption algorithm with countermeasure, the generator 20″, more particularly the section 20″a, is called upon one or more times to apply the secret parameter S to the predefined function F, so as to generate, in one or more times, a number T of elements of the sequence of values (Aₙ): A₁, . . . A_{T}. The T protection parameters a₁, . . . a_{T} are generated from these T first elements.

For example, for any k such as 1≦k≦T, aₖ=Aₖ.

Alternately, if there are T additional secret values Sec₁, . . . Sec_{T} among the secret parameters S kept in secure memory, it is possible to perform the following additional calculation:

for any k such as 1≦k≦T, aₖ=Secₖ XOR Aₖ, or aₖ=Secₖ ADD Aₖ, or aₖ=Sec_{k SUB} Aₖ, so as to transform (or distort or mask) the parameters used.

Thereafter, during an i^{th} execution EXEi of the encryption algorithm with countermeasure, the generator 20″, more particularly the section 20″a, is called upon again one or more times to apply the secret parameter S to the predefined function F, so as to generate, in one or more times, a number T of additional elements of the sequence of values (Aₙ): A_{T(i-1)}, . . . A_{Ti}. The T protection parameters a₁, . . . a_{T} are generated from these T additional elements, like previously.

For example, for any k such as 1≦k≧T, aₖ=A_{T(i-1)+k}.

Alternately, if there are T additional secret values Sec₁, . . . Sec_{T}, it is possible to perform the following additional calculation:

for any k such as 1≦k≦T, aₖ=Secₖ XOR A_{T(}ᵢ₋₁₎₊ₖ, or aₖ=Secₖ ADD A_{T(}ᵢ₋₁₎₊ₖ, or aₖ=Secₖ SUB A_{T(}ᵢ₋₁₎₊ₖ, so as to transform (or distort or mask) the parameters used.

Whatever is the method used to generate the sequence(s) of values at the origin of the protection parameters, knowing the method and secret values used by the method, including the initial parameter A₀ previously loaded into memory or during a step of the life cycle of the microcircuit device in memory EEPROM, makes it possible to find the protection parameters generated and used during the life of the device at anytime. It appears clearly that this particularity then allows simple and efficient debugging to be performed and resistance to attacks by fault injection to be improved.

The choice of the method used to generate the sequence of values and the protection parameter(s) is dictated by the contemplated application.

### 2) Application of the General Principle of the Second Embodiment to the Five Methods Described with Reference to FIGS. 4 to 8

The method used by the first, second and third methods of FIGS. 4, 5 and 6 to generate the protection parameter a during steps 100, 200, 300 and the parameters v, r2, r3 during steps 102, 202, 302 may be one of those recommended in the second embodiment. In addition, the parameters a, v, r2, r3 may have the same binary size and come from a same sequence of values (T=4). In addition, these parameters may not need to be kept in memory since they may be found at anytime from the sequence of values which is determined by the secret parameter(s) and the function F. Thus, the parameters v and then r1, r2 and r3 may be found at steps 120, 218, 312 without necessarily needing to be kept in memory during the execution of the exponentiation. At these steps 120, 218, 312, the protection parameter a may also be found to check that the integrity thereof has been kept during the exponentiation.

Likewise, the method used by the fourth and fifth methods of FIGS. 7 and 8 to generate the protection parameter a during steps 400, 500 and the parameter v during steps 402, 502 may be one of those recommended in the second embodiment. In addition, the parameters a and v may have the same binary size and come from a same sequence of values (T=2). In addition, these parameters may therefore not need to be kept in memory since they may be found at anytime from the sequence of values which is determined by the secret parameter(s) and the function F. This process including regenerating these parameters is even a useful step for the protection of the implementation against attacks by fault injection. Thus, the parameter v and then r may be found at steps 420, 518 without necessarily needing to be kept in memory during the execution of the scalar multiplication. At these steps 420, 518, the protection parameter a may also be found to check that the integrity thereof, and the integrity of the parameters used to generate it, has been kept during the scalar multiplication.

An additional protection may be added during the execution of the primitive calculation loop, in each of the aforementioned methods. A verification parameter s is previously generated according to one of the method recommended above, the parameter is adding to the parameters a and v, r1 or a, v, r1, r2 and r3. At each iteration in this calculation loop, for example at step 118 of the first method, step 216 of the second method, steps 306 and 310 of the third method, step 418 of the fourth method and step 516 of the fifth method, s is found and portions of at least one part of the binary representations or of representations according to another base b of the message M are extracted in a deterministic way using the parameter s, from the module N (in the case of RSA or RSA CRT), from the private key d, or the like. The portions are then noted Ms, Ns, ds, and the like. and possibly combined to form a verification data. The principle of this protection is to check that at each iteration, the value of the verification data is unchanged. If the verification data changes, the data M, N, d, etc. may be scrambled in order not to be discovered and an alert may be triggered. Other data than M, N and d may be used, provided that these data are used during the execution of the primitive.

It clearly appears that the countermeasure methods previously described make it possible to achieve asymmetric encryption applications protecting the private key used against attacks by auxiliary channels, while limiting the extra cost of calculation time at a very fair level.

It is in addition to be noted that the invention is not limited to the aforementioned embodiments and that, although numerous variations have been presented, other may also be contemplated in particular providing other types of transformations of the private key than those which have been described, or other asymmetric encryption applications than those treated.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

26. A countermeasure method in an electronic component implementing an asymmetric private key encryption algorithm, the method comprising:
generating a protection parameter;
calculating, using a primitive of the encryption algorithm, an intermediate data from an input data and the protection parameter;
dividing a binary representation of the private key into a plurality of binary blocks;
transforming each binary block using the protection parameter and, for each binary block transformed, performing an intermediate calculation using the primitive; and
calculating an output data by combining the intermediate data and the intermediate calculations.

27. The countermeasure method according to claim 26, further comprising dividing the binary representation of the private key so that the size of each binary block is greater or equal to that of the binary representation of the protection parameter.

28. The countermeasure method according to claim 26, further comprising dividing the binary representation of the private key into a plurality of binary blocks such that a sum of sizes of the binary blocks is greater than a size of the binary representation of the private key.

29. The countermeasure method according to claim 26, further comprising randomly determining, in an iterative way, a size of each binary block such that a value of each binary block is greater than a value of the protection parameter.

30. The Countermeasure method according to claim 26, further comprising:
choosing a size k of the binary representation of the protection parameter such that there exists an integer u≧2 such that n=k·u, where n is the size of the binary representation of the private key; and
dividing the binary representation of the private key into u binary blocks of k bits each.

31. The countermeasure method according to claim 26, wherein the primitive is a modular exponentiation of the input data by the private key for performing an encryption algorithm of RSA or RSA CRT type.

32. The countermeasure method according to claim 31, further comprising previously masking the RSA module and the input data.

33. The countermeasure method according to claim 26, wherein the primitive is a scalar multiplication of the input data by the private key, for performing an encryption algorithm based on an elliptic curve wherein the input data is a predetermined point of the elliptic curve.

34. The countermeasure according to claim 33, further comprising previously masking the predetermined point of the elliptic curve.

35. The countermeasure method according to claim 26, further comprising:
initially generating, in a reproducible way, at least one verification parameter before any execution of the primitive,
regenerating the verification parameter during or after the execution of the primitive and comparing the regenerated verification parameter with the initially generated verification parameter.

36. The countermeasure method according to claim 35, wherein the step of regenerating and comparing is performed at each iteration of the primitive when applied to a transformed binary block.

37. The countermeasure method according to claim 35, further comprising triggering an alert and scrambling at least the private key, if the step of regenerating and comparing indicates a difference between the initially generated verification parameter and the regenerated verification parameter.

38. The countermeasure method according to claim 26, wherein generating the protection parameter and/or the verification parameter comprises:
providing at least one predetermined secret parameter stored in a secure memory of the electronic component,
defining a generating function allowing for the generation of a sequence of values by successive applications of the generating function to the secret parameter, the sequence of values only being determinable from the generating function and the secret parameter,
generating at least one sequence of values from the generating function and the secret parameter, and
generating the protection parameter and/or the verification parameter in a reproducible way from at least one value of the sequence of values.

39. The countermeasure method according to claim 38, further comprising:
defining a plurality of functions, each function generating, by successive applications to at least one corresponding predetermined secret parameter stored in memory, of a corresponding sequence of values only determinable from the corresponding secret parameter and the corresponding function,
combining the plurality of sequences of values generated using a predefined relationship to generate a new sequence of values,
generating the protection parameter and/or the verification parameter in a reproducible way from at least one value of the new sequence.

40. The countermeasure method according to claim 38, further comprising:
defining a generating function, by successive applications to at least one predetermined secret parameter stored in memory, of a sequence of values only determinable from the secret parameter and the function,
combining the sequence of values generated with public parameters of the encryption algorithm to generate a new sequence of values,
generating the protection parameter and/or the verification parameter in a reproducible way from at least one value of the new sequence.

41. A microcircuit device, comprising a microprocessor configured to implement a countermeasure method of an asymmetric private key encryption algorithm, at least one secure memory to store the private key, and a data generator for the generation of a protection parameter, the device configured to:
calculate, using a primitive of the encryption algorithm, an intermediate data from an input data and the protection parameter;
divide the binary representation of the private key into a plurality of binary blocks;
transform each binary block using the protection parameter and, for each binary block transformed, perform an intermediate calculation using the primitive,
calculate an output data by combining the intermediate data and the intermediate calculations.

42. The microcircuit device according to claim 41, wherein the microprocessor is configured to randomly determine, in an iterative way, the size of each binary block such that a value of each binary block is greater than a value of the protection parameter.

43. The microcircuit device according to claim 41, wherein the data generator is configured to choose a size k of the binary representation of the protection parameter such that there exists an integer u≧2 such that n=k·u, where n is a size of the binary representation of the private key, and wherein the microprocessor is configured to divide the binary representation of the private key into u binary blocks of k bits each.

44. The microcircuit device according to claim 41, wherein the primitive is a modular exponentiation of the input data by the private key for performing an encryption algorithm of RSA or RSA CRT type.

45. The microcircuit device according to claim 41, wherein the primitive is a scalar multiplication of the input data by the private key, for performing an encryption algorithm based on an elliptic curve wherein the input data is a predetermined point of the elliptic curve.

46. The microcircuit device according to claim 41, further configured to initially generate, in a reproducible way, at least one verification parameter before any execution of the primitive, regenerate this verification parameter during or after the execution of the primitive, and compare the regenerated verification parameter with the initially generated verification parameter.

47. The microcircuit device according to claim 41, wherein the data generator is configured to generate the protection parameter and/or the verification parameter by:
generating a sequence of values by successive applications of a predetermined generating function to at least one predetermined secret parameter stored in the secure memory, the sequence of values only being determinable from the secret parameter and the generating function, and
supplying the protection parameter and/or the verification parameter in a reproducible way from at least one value of the sequence of values.

48. The microcircuit device according to claim 47, wherein the data generator is configured to:
define a plurality of functions, each function generating, by successive applications to at least one corresponding predetermined secret parameter stored in memory, of a corresponding sequence of values only determinable from the corresponding secret parameter and the corresponding function,
combine the plurality of sequences of values generated using a predefined relationship to generate a new sequence of values,
generate the protection parameter and/or the verification parameter in a reproducible way from at least one value of the new sequence.

49. The microcircuit device according to claim 47, wherein the data generator is configured to:
define a generating function, by successive applications to at least one predetermined secret parameter stored in memory, of a sequence of values only determinable from the secret parameter and the function,
combine the sequence of values generated with public parameters of the encryption algorithm to generate a new sequence of values,
generate the protection parameter and/or the verification parameter in a reproducible way from at least one value of the new sequence.

50. A portable device comprising a microcircuit device according to claim 41.
